(19) United States
(12) Patent Application Publication
(10) Pub. No.: US 2018/0103148 A1
(43) Pub. Date: Apr. 12, 2018

(54) AUTOMATED WORKFLOW TRIGGERING USING REAL-TIME SPEECH ANALYTICS

(71) Applicant: ZOOM INTERNATIONAL S.R.O., Prague (CZ)

(72) Inventor: Vaclav Slovacek, Prague (CZ)

(21) Appl. No.: 15/289,941

(22) Filed: Oct. 10, 2016

(51) Int. Cl. H04M 3/51; G10L 15/22; G10L 15/30; G10L 15/08; H04M 3/523

(52) U.S. Cl. CPC H04M 3/5183; G10L 15/22; G10L 2015/088; G10L 15/08; H04M 3/523; G10L 15/30

(57) ABSTRACT

A system for automatically automatic workflow triggering using real-time speech analytics, comprising an analytics server that receives and analyzes interaction information and a workflow server that produces workflow events based on the analysis, sends workflow events to handlers for processing, retrieves workflow-related data, and produces workflow reports for review, and a method for automatically automatic workflow triggering using real-time analytics.

### CROSS-REFERENCE TO RELATED APPLICATIONS

None.

### BACKGROUND OF THE INVENTION

### Field of the Art

The disclosure relates to the field of business operations, and more particularly to the field of automatically triggering internal workflows using real-time speech analytics.

### Discussion of the State of the Art

In business operations, “workflows” are often used to manage complex sequences of parallel or serial operations that must be performed to accomplish complex tasks, such as various data collection, form submission operations, or outbound interactions such as to perform background or credit checks, or other such operations according to the nature of a particular business or industry application. Generally, these workflows may be configured or managed through assisted means such as software management applications, however there is still a large manual element involved in workflow completion and workflows remain largely “reactive” in nature, in that action is taken only after all relevant information is collected or after explicit action is performed to initiate the workflow.

What is needed, is a means to monitor and analyze business interactions, and use this analysis to automatically and proactively trigger workflow events in real-time based on interaction content and context.

### SUMMARY OF THE INVENTION

Accordingly, the inventor has conceived and reduced to practice, in a preferred embodiment of the invention, a system and method for automatic workflow triggering using real-time speech analytics.

According to a preferred embodiment of the invention, a system for automatic workflow triggering using real-time analytics, comprising an analytics device comprising at least a plurality of programming instructions stored in a memory and operating on a processor of a network-connected computing device, configured to receive at least a plurality of interaction-specific information from a plurality of contact center systems, configured to then analyze at least a portion of the plurality of interaction-specific information, and configured to provide at least a portion of the analysis results to a workflow triggering device. The system further made up of a workflow triggering device comprising at least a plurality of programming instructions stored in a memory and operating on a processor of a network-connected computing device and configured to receive at least a plurality of analysis results from an analytics server, also configured to produce a plurality of workflow events based at least in part on at least a portion of the analysis results, and further configured to provide at least a portion of the plurality of workflow events for use by system components or human users communicating via a network, is disclosed.

According to another preferred embodiment of the invention, a method for automatic workflow triggering using real-time analytics, comprising the steps of: receiving, at an analytics device comprising at least a plurality of programming instructions stored in a memory and operating on a processor of a network-connected computing device and configured to receive at least a plurality of interaction-specific information from a plurality of contact center systems, and configured to analyze at least a portion of the plurality of interaction-specific information, and configured to provide at least a portion of the analysis results to a workflow triggering device, a plurality of interaction-specific information; analyzing at least a portion of the interaction-specific information; producing, using a workflow triggering device comprising at least a plurality of programming instructions stored in a memory and operating on a processor of a network-connected computing device and configured to receive at least a plurality of analysis results from an analytics device, and configured to produce a plurality of workflow events based at least in part on at least a portion of the analysis results, and configured to provide at least a portion of the plurality of workflow events for use by system components or human users communicating via a network, a plurality of workflow events based at least in part on the analysis results; optionally sending at least a portion of the plurality of workflow events to a plurality of external systems for use in workflow processing; optionally sending at least a portion of the plurality of workflow events to a plurality of human agents for use in workflow handling; optionally collecting a plurality of information from a plurality of data sources, the information being based at least in part on at least a portion of the plurality of workflow events; producing a workflow report based at least in part on at least a portion of the plurality of workflow events; and providing at least a portion of the workflow report for review by an administrator, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for automatically triggering workflow events using real-time speech analytics, according to a preferred embodiment of the invention.

FIG. 6 is a block diagram of an exemplary system architecture for automatically triggering workflow events using real-time speech analytics, illustrating the use of distributed workflow handlers communicating via a network.

FIG. 7 is a block diagram of an exemplary system architecture for automatically triggering workflow events using real-time speech analytics, illustrating the use of off-site analytics via a software-as-a-service arrangement.

FIG. 8 is a flow diagram illustrating an exemplary method for automatically triggering workflow events using real-time speech analytics, according to a preferred embodiment of the invention.

FIG. 9 is a flow diagram illustrating the use of real-time keyword analysis to automate workflow, according to a preferred embodiment of the invention.

### DETAILED DESCRIPTION

The inventor has conceived, and reduced to practice, in a preferred embodiment of the invention, a system and method for automatic workflow triggering using real-time speech analytics.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

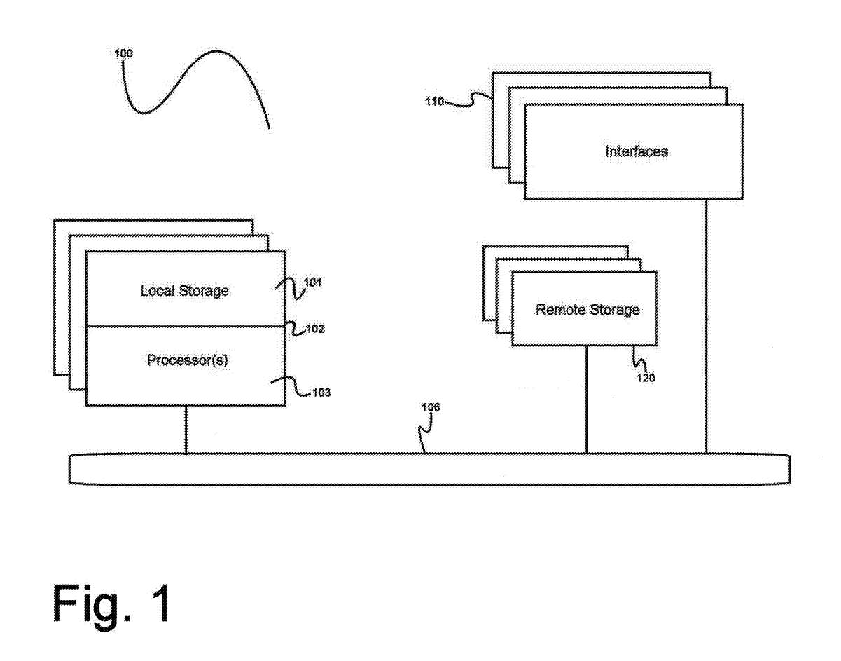

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

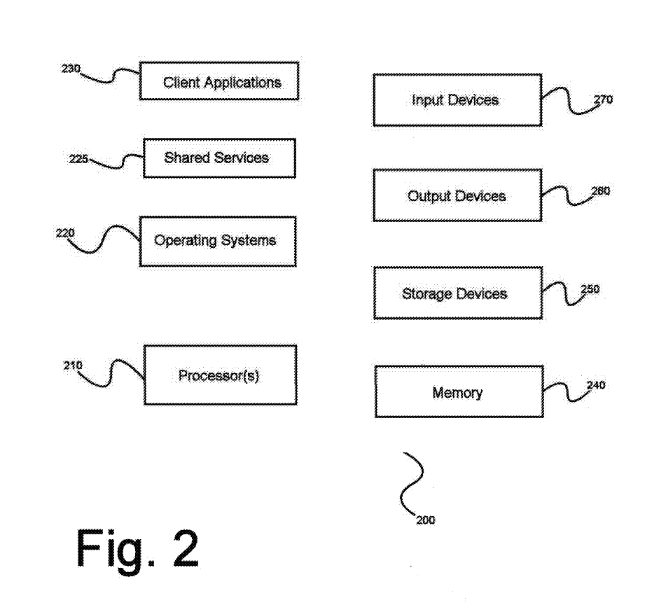

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

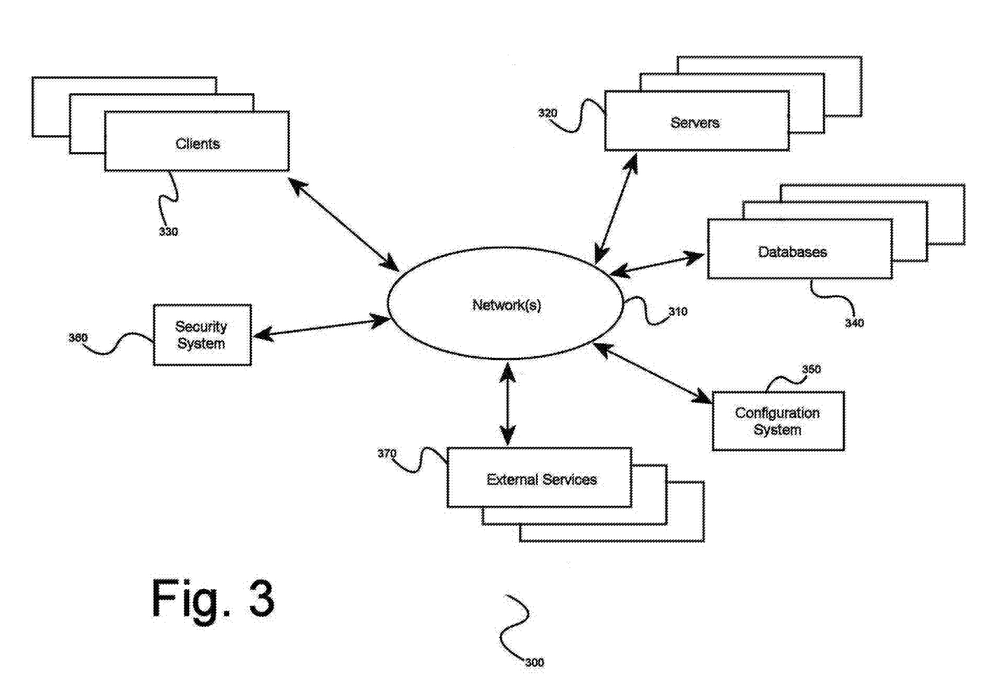

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

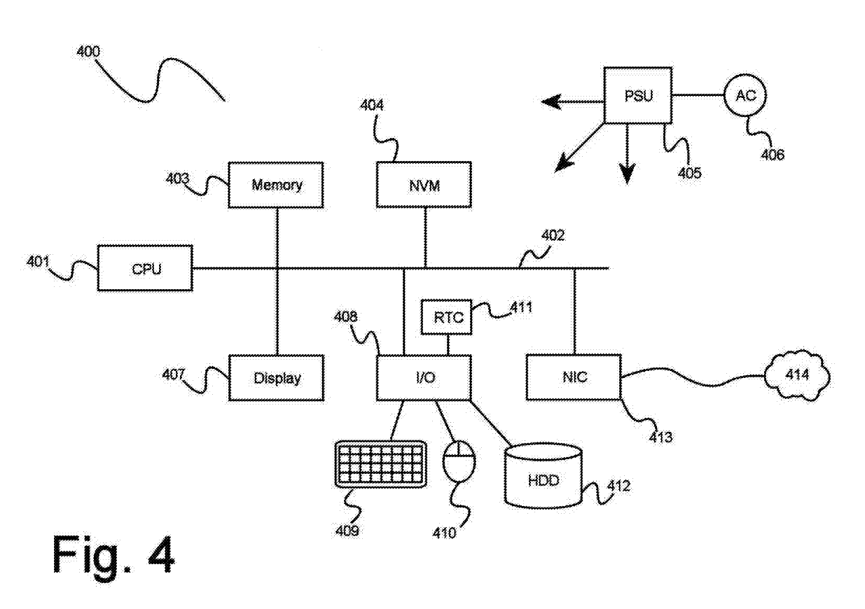

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

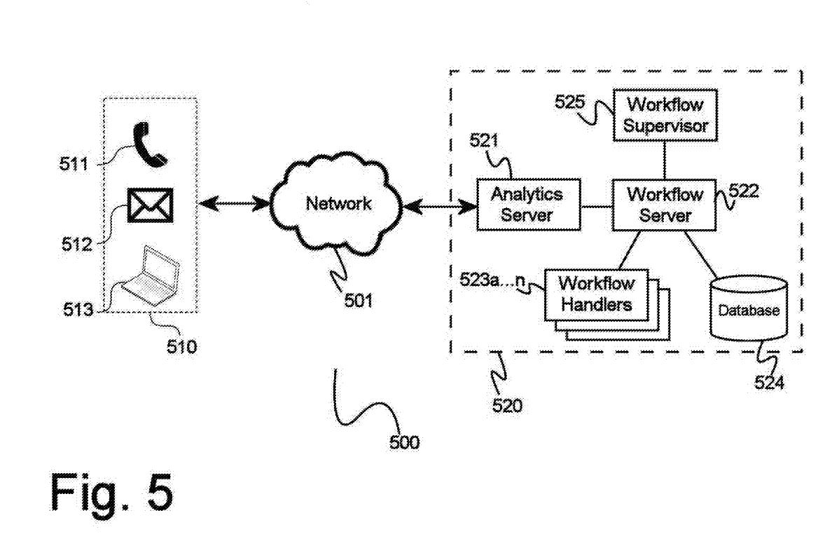

FIG. 5 is a block diagram of an exemplary system architecture 500 for automatically triggering workflow events using real-time speech analytics, according to a preferred embodiment of the invention. According to the embodiment, a variety of client devices 510 such as a telephone 511, email 512, or personal computer 513 may communicate with a business or organization 520 via a network 501 such as the Internet or other suitable communication network. An organization 520 may operate a number of workflow handlers 523a-n, that may be hardware, software components configured to perform particular functions or carry out processes during the handling of a workflow (such as a bulk scanner for processing received documents via mail, or an automated email or dialing system for automated form submission, for example), or they may be devices directed by human representatives that carry out workflow tasks manually, such as interacting with customers or systems for data collection or entry (for example, in a banking arrangement, a human representative may speak with a customer to review the terms of a loan application as part of a loan application workflow). Organization 520 may also operate a plurality of data storage 524 such as to maintain client account information or scanned copies of documents, and to make stored information available for use as needed during workflow processing. A workflow supervisor 525 may be an automated system or a human directed device, optionally also operating as a workflow handler 523a-n according to a particular arrangement, that may review workflows after presumed completion to check for residual unfinished tasks or to review final results (for example, a loan examiner that may review a completed loan application after an appropriate workflow is finished processing, or an account manager reviewing the results of a workflow making changes to a number of customer accounts).

According to the embodiment, an analytics server 521 may be utilized, comprising at least a plurality of programming instructions stored in a memory 403 and operating on a processor 401 of a network-connected computing device 400 (as described above, referring to FIG. 4) and configured to receive and analyze interaction information and to provide the results of analysis to a workflow server 522, comprising at least a plurality of programming instructions stored in a memory 403 and operating on a processor 401 of a network-connected computing device 400 (as described above, referring to FIG. 4) and configured for use in producing workflow events (such as to begin processing a particular workflow based on the content of an interaction, as described below). For example, analytics server 521 may receive email-based interaction information pertaining to a particular interaction being handled at a representative's workstation, and may identify certain key words or phrases within the interaction such as date or time information (for example, if a customer sends an email message as part of an interaction, requesting contact within a specific time window), or that may have been configured as indicators of particular workflow operations that may be needed or may be omitted. For example, if a customer's speech indicates that they have submitted a loan application previously, an existing application workflow may be reviewed or resumed to expedite a new loan application process, such as to “pick up where it left off”, or to incorporate information from a previous workflow such as approval information or the results of credit or background checks.

Analytics server 521 may then provide the results of analysis operations to a workflow server 522, that may utilize these results to produce a plurality of workflow events corresponding to workflow tasks or processes to be carried out. For example, if analysis indicates that a customer is calling to apply for a loan (in an exemplary banking use case), workflow server 522 may begin processing a loan application workflow to expedite the application process for the customer. For example, workflow events may comprise information retrieval from a database 524 (for example, to retrieve a customer's account information or to review previous workflows that may be relevant to the current one), or they may comprise instructions to a workflow handler to perform particular processing functions, such as to direct a bulk scanner to perform optical character recognition (OCR) on a number of received documents, or to direct a human handler to perform a credit check on a customer. Workflow server 522 may then provide results of workflow operations to a workflow supervisor 525 for review, such as to check for completion or to review particular results. Results may be reviewed for individual workflow events, or for a workflow as a whole after completion, or a combination thereof as appropriate. For example, a supervisor 525 may be sent the results of a credit check for review while the rest of a loan application workflow is still processing, and then when the application is completed it may be provided in a final review as well.

In this manner, analysis may be performed on historical or stored interaction information, on interaction information immediately after an interaction's completion, as well as on “live” or real-time interaction information for interactions that may be currently in progress Workflow events may be automatically triggered based on analysis and then sent out to various handlers for processing, for example to automatically process documents or other data, send outbound communication such as form submission or information requests, or to provide pertinent information and needed tasks to human handlers to be carried out or reviewed. Additionally, through the use of real-time analysis during interactions, workflows can be pre-emptively triggered in response to interaction content such as via speech analytics to identify key words or phrases. Specific workflow actions or processes may be carried out to expedite a workflow execution by completing tasks before a workflow would ordinarily begin in traditional embodiments, and additional information may be identified or retrieved as needed based on analysis results such as conversation content or context of an interaction. For example, if a customer calls in to begin a loan application, speech analytics may identify the nature of their interaction while they are discussing their loan with a representative. Basic loan application processes may, for example, be carried out while additional details are discussed during the interaction, such as to collect basic customer information and perform credit checks while the monetary amount of the loan is settled.

### Detailed Description of Exemplary Embodiments

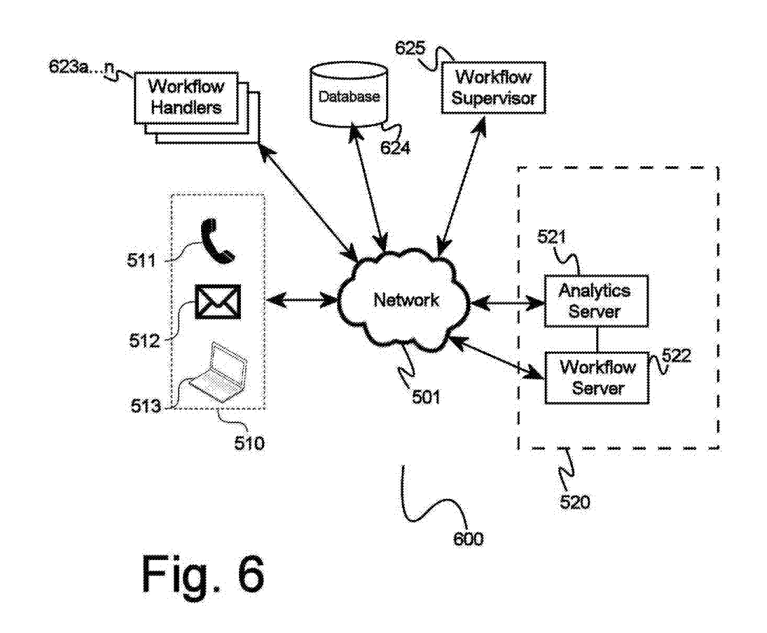

FIG. 6 is a block diagram of an exemplary system architecture 600 for automatically triggering workflow events using real-time speech analytics, illustrating the use of distributed workflow handlers communicating via a network. According to the embodiment, a variety of client devices 510 such as a telephone 511, email 512, or personal computer 513 may communicate with a business or organization 520 via a network 501 such as the Internet or other suitable communication network. An organization 520 may operate a number of workflow handlers 623a-n, that may be hardware or software components configured to perform particular functions or carry out processes during the handling of a workflow (such as a bulk scanner for processing received documents via mail, or an automated email or dialing system for automated form submission, for example), or they may be human representatives that carry out workflow tasks manually, such as interacting with customers or systems for data collection or entry (for example, in a banking arrangement, a human representative may speak with a customer to review the terms of a loan application as part of a loan application workflow). Organization 520 may also operate a plurality of data storage 624 such as to maintain client account information or scanned copies of documents, and to make stored information available for use as needed during workflow processing. A workflow supervisor 625 may be an automated system or a human user, optionally also operating as a workflow handler 623a-n according to a particular arrangement, that may review workflows after completion to check for completion or to review final results (for example, a loan examiner that may review a completed loan application after an appropriate workflow is finished processing, or an account manager reviewing the results of a workflow making changes to a number of customer accounts).

According to the embodiment, a plurality of remote workflow handlers 623a-n may communicate via network 501, for example remote system components such as scanners or human handlers such as customer service agents, account managers, or specialized staff for handling particular workflow tasks. In this manner, a variety of third-party or cloud-based workflow handlers may be utilized to complete workflow tasks according to the embodiment, for example to utilize additional or alternate functionalities provided by third-party vendors or to utilize distributed staff members. Additionally, a plurality of cloud-based databases 624 may be utilized for distributed storage, for example to utilize third-party customer account storage or databases of product information, or any other such network-connected storage. Additionally, a workflow supervisor 625 may operate remotely via network 501, for example so that a single supervisor may review workflow operations for a plurality of organizations 520, or so that a workflow supervisor may operate from a remote office without needing to be connected to an internal network within an organization 520.

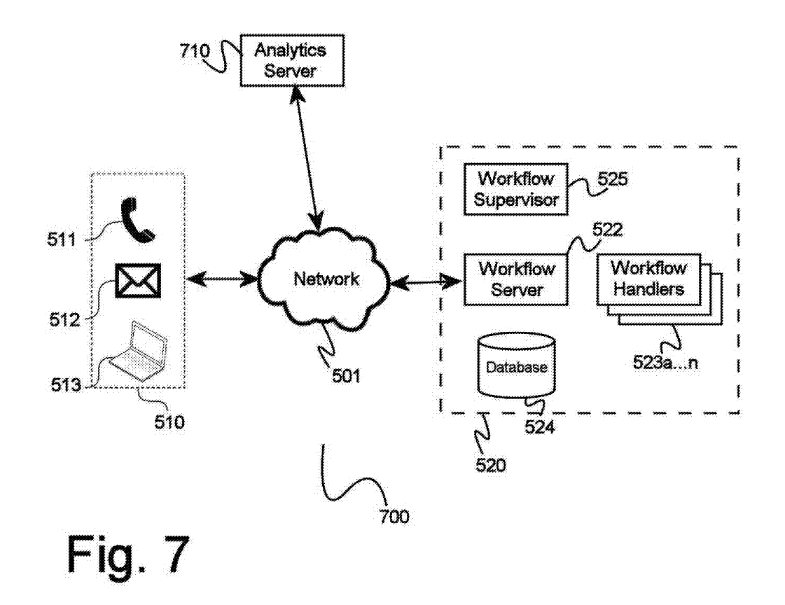

FIG. 7 is a block diagram of an exemplary system architecture 700 for automatically triggering workflow events using real-time speech analytics, illustrating the use of off-site, networked analytics server comprising at least a plurality of programming instructions stored in a memory 403 and operating on a processor 401 of a network-connected computing device 400 (as described above, referring to FIG. 4). According to the embodiment, a variety of client devices 510 such as a telephone 511, email 512, or personal computer 513 may communicate with a business or organization 520 via a network 501 such as the Internet or other suitable communication network. An organization 520 may operate a number of workflow handlers 523a-n, that may be hardware or software components configured to perform particular functions or carry out processes during the handling of a workflow (such as a bulk scanner for processing received documents via mail, or an automated email or dialing system for automated form submission, for example), or they may be human representatives that carry out workflow tasks manually, such as interacting with customers or systems for data collection or entry (for example, in a banking arrangement, a human representative may speak with a customer to review the terms of a loan application as part of a loan application workflow). Organization 520 may also operate a plurality of data storage 524 such as to maintain client account information or scanned copies of documents, and to make stored information available for use as needed during workflow processing. A workflow supervisor 525 may be an automated system or a human user, optionally also operating as a workflow handler 523a-n according to a particular arrangement, that may review workflows after completion to check for completion or to review final results (for example, a loan examiner that may review a completed loan application after an appropriate workflow is finished processing, or an account manager reviewing the results of a workflow making changes to a number of customer accounts).

According to the embodiment, a networked analytics server 710 may be utilized in addition to or in place of an analytics server operated by a business organization 520 (as described previously, referring to FIG. 5) by communicating with systems operated by an organization (as described above) via a network. For example, a networked analytics server 710 may be operated by a business in an offsite location physical separate from the same business, for example to service multiple business locations using a single analytics server 710. In this manner, it may be appreciated that analytics may be performed via a network 701, and may optionally be provided by a third party to a plurality of contact centers as clients.

Such an arrangement may optionally be utilized in addition to a distributed arrangement described above (referring to FIG. 6), facilitating a distributed business environment where analysis may be performed over a network, as well as workflow handling. Such distributed and cloud-based arrangements may be desirable, for example, to accommodate analysis and real-time workflow triggering in an existing business environment without the need for expensive or time-consuming architecture changes, and in this manner it can be appreciated that the analysis and workflow triggering features described may easily be added to any organization regardless of physical, geographic, or network arrangement of system components or human agents.

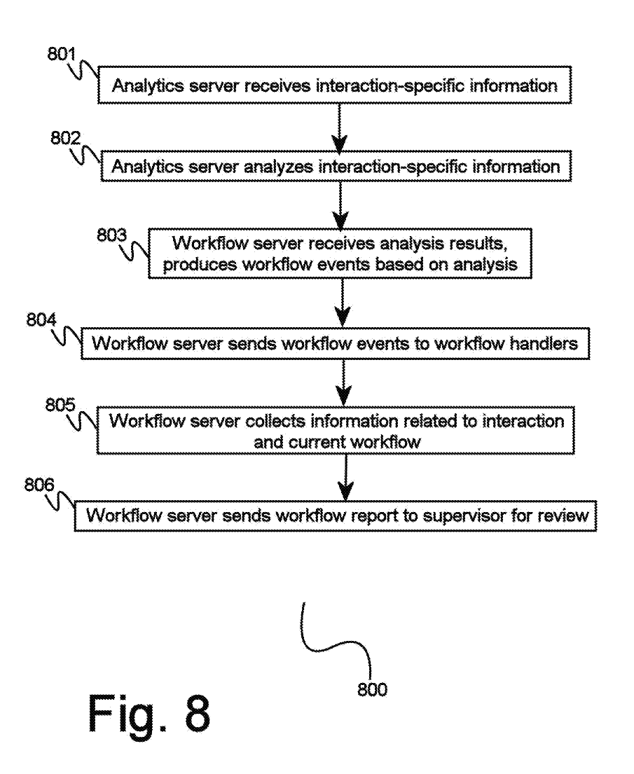

FIG. 8 is a flow diagram illustrating an exemplary method 800 for automatically triggering workflow events using real-time speech analytics, according to a preferred embodiment of the invention. In an initial step 801, an analytics server may receive a plurality of interaction-specific information, for example by reviewing interactions after they are concluded or by monitoring interactions in progress for real-time analytics. In a next step 802, analytics server may then analyze interaction details, for example performing speech analytics on audio from a telephone call or other voice-based interaction being monitored, or text-based analysis of email or other text-based interactions, either stored or ongoing. In a next step 803, analysis results may be provided to a workflow server that may produce a plurality of workflow events based on the analysis results. For example, identified key words or phrases may be used to trigger specific workflow processes such as data collection or form submission. In a next step 804, workflow events may be provided to external handlers for review or execution, such as sending a workflow event for data collection to a database to request the needed information, or providing a form to an email server to be sent or a human agent for manual submission. In a next step 805, additional information may be collected pertaining to the current workflow or to a particular interaction, for example to receive additional information in response to workflow events for data collection, or to review the results of workflow process execution. In a final step 806, the workflow server may report on the workflow progress, status, or results to a workflow supervisor, that may be an automated software application such as for logging or reporting, or may be a human agent that may review workflow reports (for example, to perform completion checks or to review details). In this manner, analysis may be used to drive automated workflow operation through the use of triggered events based on the content of interactions, and human agents may be “kept in the loop” for various purposes as needed, such as to perform manual workflow operations or to monitor, audit, or review operation.

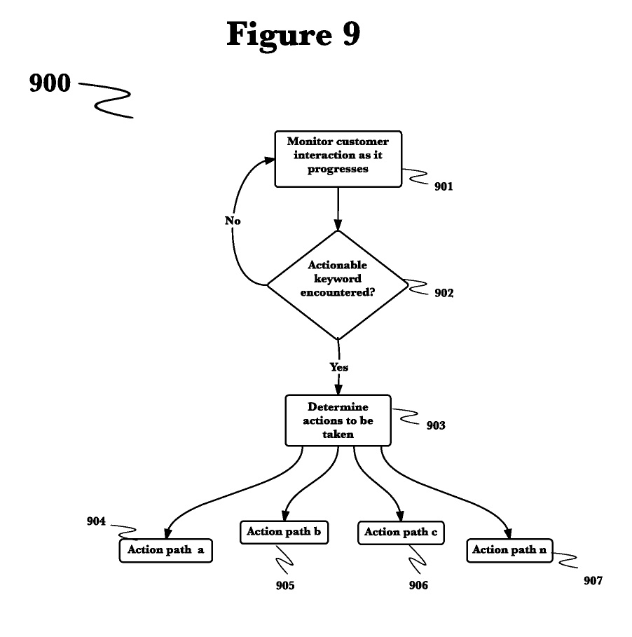

FIG. 9 is a flow diagram illustrating an exemplary method 900 for use of real-time keyword analysis to automate workflow, according to a preferred embodiment of the invention. In the initial step 901 the analytics server previously described (521 in FIG. 5) monitors a customer interaction depicted as 510 of FIG. 5 with the system 520. This interaction may be a voice interaction, an email or an instant message, all of which are analyzed for the presence of a plurality of specific keywords that may indicate that a specific preprogrammed, automated workflow from a large plurality of potential workflows is requested 902. As an example, for a business that pre-manufactures, installs and services storage sheds, receiving a voice interaction from a customer containing the words “buy” or “purchase” would result in much different pre-programmed messages arriving at the step to determine the next appropriate actions 903 than a voice interaction with the words “leak” or “broken” present. When a specific keyword is encountered, it is converted by the analytics server 521 into signals to be passed to the action determination step 903 while the analytics server 521 continues to monitor the current interaction 901. Upon determination that one or more selective keywords for a particular workflow are present, the exact automated and human mediated actions are determined 903. This determination is performed by the workflow server as previously described (522 in FIG. 5), which uses the signals sent to it by the analytics server 521. The workflow server 522, depending on the monitored keyword driven request will then formulate a pre-programmed set of actions using both the request dependent signals sent by the analytics server 521 and, a plurality of other factors that are available to it (not depicted) to implement a specific set of actions to be taken 904, 905, 906, 907. This set may encompass a single action or a plurality of actions. For example, re-focusing on the “buy” or “purchase” keywords monitored in steps 901 and 902, using the regional information of the caller, as captured from the area code and exchange of the caller's phone number; and shed model specific keywords also captured and transmitted in steps 901 and 902 the actions taken might be 1) to send out brochures for those models. 2) to schedule a follow-up sales call for two weeks with the regional sales person. In a more competitive area, the follow-up might be faster or incentives might also be mailed or emailed (if available) in addition to the previous described steps. Keywords indicating that a sale has been made in a particular geographical location might result in 1) Inventory being automatically reserved from stock, if present, otherwise manufacturing work orders automatically submitted at the factory for the desired model and delivery, and installation time tables automatically shifted, if needed. 2) Work permit applications being automatically initiated. 2) Financing arrangements being started with the preferred local bank (if requested). 3) Installers being alerted to contact the buyer at a particular time point to schedule delivery of the unassembled shed and installation. There are, of course a very large plurality of other examples for uses of automatic triggering of workflow events using real-time analytics known to those skilled in the art. These chosen here were used for simplified illustrative purposes only and should in no way be seen to limit the invention.

The skilled person will be aware of a range of possible modifications of the various embodiments described above. Accordingly, the present invention is defined by the claims and their equivalents.

1. A system for automatic workflow triggering using real-time speech analytics, comprising:
an analytics server comprising a memory and a processor and a plurality of programming instructions stored in the memory and operating on the processor, the programming instructions, when executed by the processor, cause the processor to:
receive at least a plurality of interaction-specific information from a plurality of contact center systems, wherein the interaction-specific information comprises at least a plurality of speech-based audio data based at least in part on an interaction that is currently being handled by at least a portion of the plurality of contact center systems, and
analyze at least a portion of the plurality of interaction-specific information, the analyzed portion comprising at least the speech-based audio data based on the interaction that is currently being handled; and
provide at least a portion of results of the analysis to a workflow triggering server; and
wherein the workflow triggering server comprises a memory and a processor and a plurality of programming instructions stored in the memory of the workflow triggering server and operating on the processor of the workflow triggering server, the programming instructions of the workflow triggering server, when executed by the processor of the workflow triggering server, cause the processor of the workflow triggering server to:
receive at least a plurality of results of the analysis from the analytics server,
produce a plurality of workflow events based at least in part on at least a portion of the results of the analysis,
direct the operation of a plurality of external systems via a network, the operation comprising at least the execution of a portion of the plurality of workflow events;
receive information from a plurality of data sources, the information being based at least in part on the execution of at least a portion of the plurality of workflow events by at least a portion of the plurality of external systems; and
produce a report comprising at least a portion of the received information.

2. The system of claim 1, wherein the workflow triggering server receives at least a plurality of workflow-related information from a plurality of connected data sources, the information being based at least in part on at least a portion of the plurality of workflow events.

3. The system of claim 1, wherein the analytics server is configured to perform speech analysis on at least a portion of the plurality of speech-based audio data.

4. A method for automatic workflow triggering using real-time speech analytics, comprising the steps of:
receiving, at an analytics server comprising a memory and a processor and a plurality of programming instructions stored in the memory and operating on the processor, the programming instructions, when executed by the processor, cause the processor to receive at least a plurality of interaction-specific information from a plurality of contact center systems, wherein the interaction-specific information comprises at least a plurality of speech-based audio data based at least in part on an interaction that is currently being handled by at least a portion of the plurality of contact center systems, and analyze at least a portion of the plurality of interaction-specific information, and provide at least a portion of the results of the analysis to a workflow triggering server, a plurality of interaction-specific information;
analyzing at least a portion of the interaction-specific information, the analyzed portion comprising at least the speech-based audio data based on the interaction that is currently being handled;
producing, using the workflow triggering server comprising a memory and a processor and a plurality of programming instructions stored in the memory of the workflow triggering server and operating on the processor of the workflow triggering server, the programming instructions of the workflow triggering server, when executed by the processor of the workflow triggering server, cause the processor of the workflow triggering server to receive at least a plurality of results of the analysis from the analytics server, and produce a plurality of workflow events based at least in part on at least a portion of the results of the analysis, and provide at least a portion of the plurality of workflow events for use by system components or human users communicating via a network, a plurality of workflow events based at least in part on the results of the analysis;
optionally sending at least a portion of the plurality of workflow events to a plurality of external systems for use in workflow processing;
optionally sending at least a portion of the plurality of workflow events to a plurality of human agents for use in workflow handling;
collecting a plurality of information from a plurality of data sources, the information being based at least in part on the execution of at least a portion of the plurality of workflow events;
producing a workflow report based at least in part on at least a portion of the received information; and
providing at least a portion of the workflow report for review by a human user.
